(19) United States
(12) Patent Application Publication
(10) Pub. No.: US 2015/0321125 A1
(43) Pub. Date: Nov. 12, 2015

(54) FILTER AND RELATED METHODS FOR USE DURING WELLBORE OPERATIONS

(71) Applicant: BAKER HUGHES INCORPORATED, Houston, TX (US)

(72) Inventors: Mark A. Jenkins, Celle (DE); Ingo Forstner, Ahnsbeck (DE)

(73) Assignee: BAKER HUGHES INCORPORATED, Houston, TX (US)

(21) Appl. No.: 14/260,685

(22) Filed: May 8, 2014

(51) Int. Cl. B01D 29/11

(52) U.S. Cl. CPC B01D 29/112

(57) ABSTRACT

A high-strength meshed bag with a ring fits into a seat between downhole or surface connections in a conduit or into a dedicated filter sub assembly. The filter filters a flowing fluid inside the conduit. The bag may be formed of aramid fibers with a molded ring. The bag may have varying mesh properties along its surface. There may be several mesh layers in the bag. The conduit may include surface pipes, hoses, surface fluid handling equipment, a drill string, or production string. The bag may be designed to let drop balls through when desired while catching much smaller particles otherwise.

### CROSS-REFERENCE TO RELATED APPLICATIONS

None.

### BACKGROUND OF THE DISCLOSURE

1. Field of the Disclosure

This disclosure relates generally to filtering devices and methods for oilfield fluids.

2. Description of the Related Art

Fluids circulated into a wellbore from surface, which may be dry land, a rig at a water surface, or a seabed, may contain many different types of contaminants such as cuttings and metal shavings. The particle size of these contaminants can vary from microns to inches. Additionally, rig crews may inadvertently drop tools, gloves, rags or other unwanted materials into the circulating drilling fluid. These contaminants and unwanted materials, hereinafter referred to as debris, can be harmful. For instance, the debris can cause failures in the electrical components of the bottomhole assemblies.

The present disclosure addresses the need to cost-efficiently filter fluids circulated into the wellbore.

### SUMMARY OF THE DISCLOSURE

In aspects, the present disclosure provides a filter for separating particles entrained in a fluid flowing into a wellbore from a surface location. The filter may include a section of a conduit along which the fluid flows, a ring fixed along the conduit, and a bag connected to the ring. The bag may be formed of at least a non-metal material and have perforations through which the fluid flows.

Illustrative examples of some features of the disclosure thus have been summarized rather broadly in order that the detailed description thereof that follows may be better understood, and in order that the contributions to the art may be appreciated. There are, of course, additional features of the disclosure that will be described hereinafter and which will form the subject of the claims appended hereto.

### BRIEF DESCRIPTION OF THE DRAWINGS

For detailed understanding of the present disclosure, references should be made to the following detailed description of the preferred embodiment, taken in conjunction with the accompanying drawings, in which like elements have been given like numerals and wherein:

FIG. 1 illustrates a drilling system that incorporates one or more filters made in accordance with embodiments of the present disclosure;

FIG. 2 sectionally illustrates a section of a conduit that includes a filter made in accordance with embodiments of the present disclosure; and

FIG. 3A-E illustrate various other embodiments of filters made in accordance with the present disclosure.

### DETAILED DESCRIPTION OF THE DISCLOSURE

The present disclosure relates to devices and methods for surface and/or downhole filtering a fluid used during the drilling, completion, recompletion, or workover of a well or while producing fluids from a well. As used herein, the term “drilling” refers to any and all activities associated with forming a wellbore: i.e., the general process(es) from the moment where there is no hole section until the drilling and logging BHAs and pipe conveyed wireline tools are out of the newly existing, uncompleted, hole section. Thus, “drilling” is not limited to on-bottom-drilling during which rock is being cut, but also hole cleaning, reaming, back-reaming, etc. The fluid may be an engineered fluid or a naturally occurring fluid. Illustrative, but not limiting, examples of engineered fluids, which do not naturally occur, include drilling fluids, lost circulation material (LCM), and fracturing fluids. Naturally occurring fluids include water, seawater, gas, nitrogen, and brine. These fluids may be liquids, liquid mixtures or other fluid-like materials such as gels or slurries. The present disclosure is susceptible to embodiments of different forms. There are shown in the drawings, and herein will be described in detail, specific embodiments of the present disclosure with the understanding that the present disclosure is to be considered an exemplification of the principles of the disclosure, and is not intended to limit the disclosure to that illustrated and described herein. While the present disclosure is described in the context of a hydrocarbon producing well, the present teachings may be equally applied to a water well, a geothermal well, or any other human made feature for accessing the subsurface.

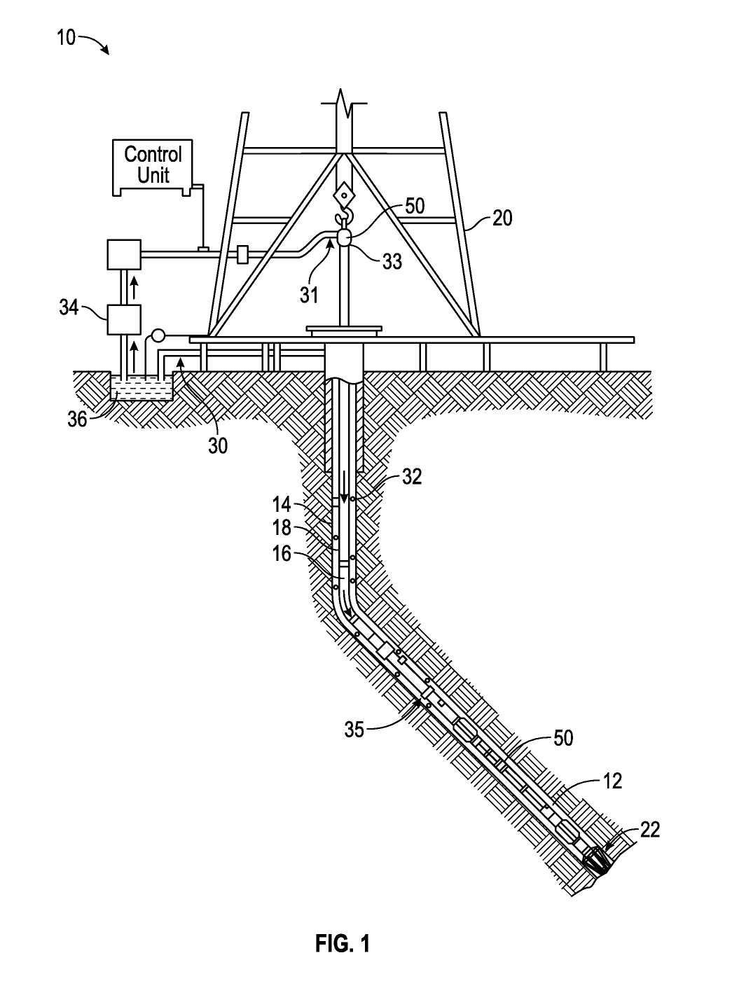

Referring now to FIG. 1, there is shown an embodiment of a drilling system 10 that may use the filtering devices and methods according to the present disclosure. While a land-based rig is shown, these concepts and the methods are equally applicable to offshore drilling systems. The system 10 shown in FIG. 1 has a bottomhole assembly (BHA) 12 conveyed in a borehole 14 via a drill string 16. The drill string 16 includes a tubular string 18, which may be drill pipe or coiled tubing, extending downward from a rig 20 into the borehole 14. A drill bit 22, attached to the drill string end, disintegrates the geological formations when it is rotated to drill the borehole 14.

The drilling system 10 also includes a drilling fluid circulation system 30 that circulates drilling fluid in a conduit 31. The drilling fluid may be an oil-based drilling mud, a water-based drilling mud, or a synthetic drilling mud. The conduit 31 may be formed by a surface section 33 and a downhole section 35. The surface portion 33 of the conduit 31 may include any number of devices and flow lines known to those skilled in the art, e.g., hoses associated with the mud pumps 34, the flow lines to the kelly, a continuous circulation system, etc. The downhole section 35 includes the drill string 16 and an annulus 32 formed between the drill string 16 and the wall of the borehole.

During operation, one or more mud pumps 34 at the surface draw the drilling fluid, or “drilling mud,” from a mud pit 36 and pump the drilling mud via the surface section 33 of the conduit 31 into the borehole 14 via the drill string 16. The drilling mud exits at the drill bit 22 and flows up the annulus 32 to the surface. The returning drilling fluid may be processed, cleaned and returned to the mud pit 36 or disposed of in a suitable manner. The circulating drilling mud serves a number of functions, including cooling and lubricating the drill bit 22, cleaning the borehole of cuttings and debris, and maintaining a suitable fluid pressure in the wellbore (e.g., an overbalanced or at-balanced condition). As discussed below, an exemplary filter 50 according to the present disclosure may be used anywhere along the conduit surface section 33 and/or along at the downhole section 35. The exemplary filter 50 may be positioned in a bore or an annulus of the surface section 33 or downhole section 35.

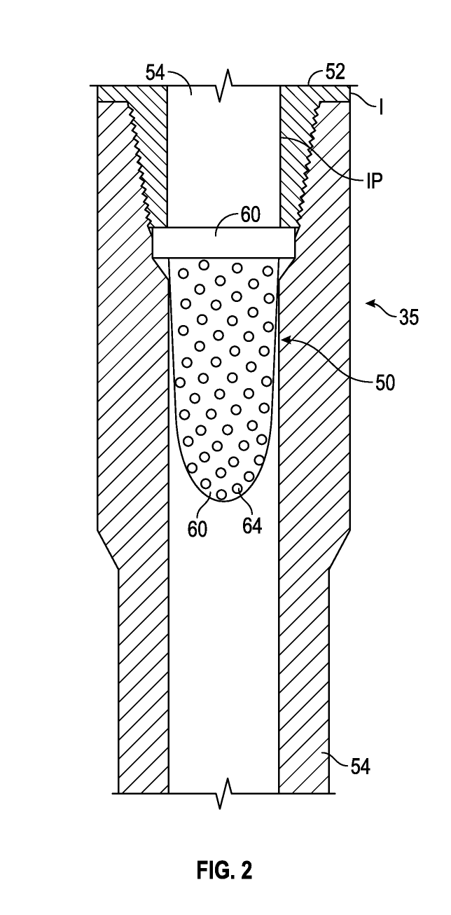

Referring now to FIG. 2, there is shown one embodiment of a filter 50 according to the present disclosure. The filter 50 may be positioned at a conduit downhole section 35, e.g., at a connection between two components of the drill string 16. The components may be a joint of drill pipe, a quick disconnect, a sub, sections of the BHA 12 (FIG. 1), a drill collar or any other part of the drill string 16. Alternatively, the filter 50 may be positioned in a dedicated sub assembly (not shown). The sub assembly (not shown) may be a tubular member having an interior space for receiving the filter 50 and may be configured to inserted into the drill string 16 by any suitable arrangement (e.g., threaded connections). Merely for the ease of discussion, the filter 50 is shown at a connection between an upper pipe joint 52 and a lower pipe joint 54.

The filter 50 may include a ring 60 and a bag 62. For embodiments wherein the filter 50 is used in a bore of the drill string 16, the ring 60 may be fixed to an inner surface of the bore of the conduit 35. For example, the ring 60 may seat between the upper pipe joint 52 and the lower pipe joint 54. The ring 60 maybe formed of a material that is sufficiently stiff enough to secure the bag 62 within a bore 64 of the drill string 16 or a surface conduit 33. In one embodiment, the ring 60 is formed of an injection molded plastic. However, other materials such as metals or ceramics may be used to form the ring 60. The bag 62 may be formed in any shape that is complementary to the bore 64, e.g., tubular, conical, frusto-conical, etc. The bag 62 includes perforations 64 through which fluid flows between the upper pipe joint 52 and the lower pipe joint 54. The perforations may be sized and shaped to block passage of one or more entrained materials/debris that are greater than a specified size. The perforations 64 may be of any desired size and shape. Regarding shape, the perforations 64 may be slots or slits, for instance. Further, the size of perforations may be variable. For example, the material of the bag 62 and the shape of the perforations 64 can allow the size to vary depending on flowrate and/or mud viscosity. The perforation size may also be varied using a mechanical device such as a tensioned rope or using a chemical agent added to the flowing fluid.

In embodiments, the bag 62 may be formed of a material that has relatively high-strength and is cost-effective to manufacture. In embodiments, the bag 62 is formed of a non-metal, such as a polymer. Illustrative suitable non-metals include, but are not limited to, polymers such as plastics, elastomers, fluoropolymers, polyimide, polyetheretherketone (PEEK), polyetherketoneketone (PEKK), nylon, acetal, polyester, polycarbonate, olefins, polystyrene, polyvinyl chloride, polypropylene, etc. as well as composite materials. In other embodiments, the bag 62 may formed of a composite material that includes a metal and a non-metal. The bag 62 may be formed by injection molding, compression molding, extrusion, casting, transfer molding, blow molding, powder processing, stock machining, weaving, or one or several other suitable processes. In one embodiment, the bag 62 may be formed of woven aramid fibers. Some embodiments of the bag 62 may be pliable. As used herein, a pliable material is one that allows the bag 62 to fold, twist, bend, or otherwise deform without undergoing substantial plastic deformation.

In one aspect, the material for the bag 62 may be selected based on the fluid to be filtered. For example, the material may be selected relative to the type of drilling fluid (e.g., oil based, water based, synthetic, etc.) Also, drilling fluid can include weighting agents (e.g., barite) and additives (e.g., emulsifiers). The material for the bag 62 can be formulated to be chemically and physically non-reactive to the components of the drilling or the carrier fluid. Likewise, the material for the bag 62 may be non-reactive to other naturally occurring or engineered fluids (e.g., lost circulation material) and/or the solid particles in the flowing fluid (e.g., sand, gravel, etc.). Illustrative material properties that may be matched to the flowing fluid include surface tension, respective differential pressure build-up, cutting resistance, hardness, wear resistance, etc.).

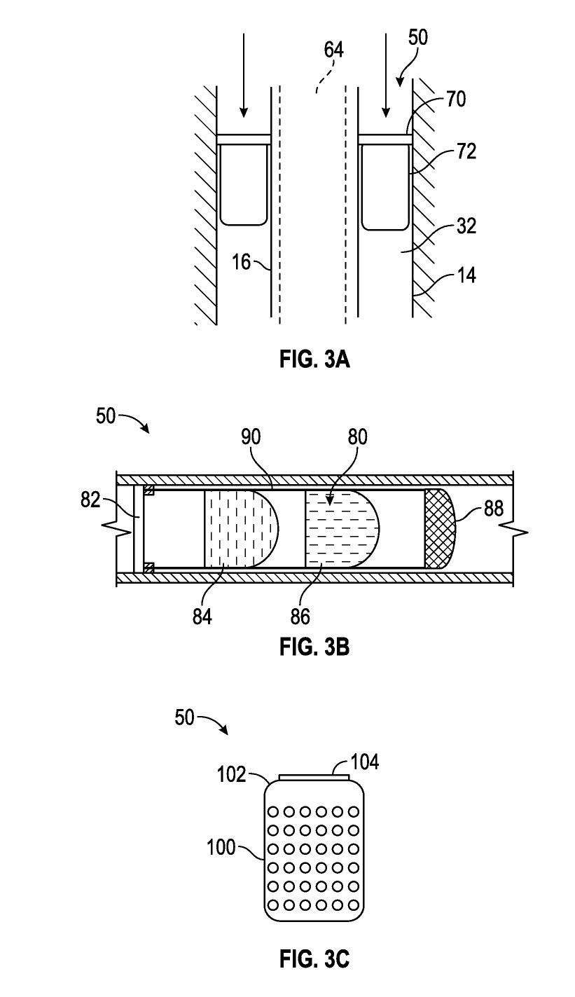

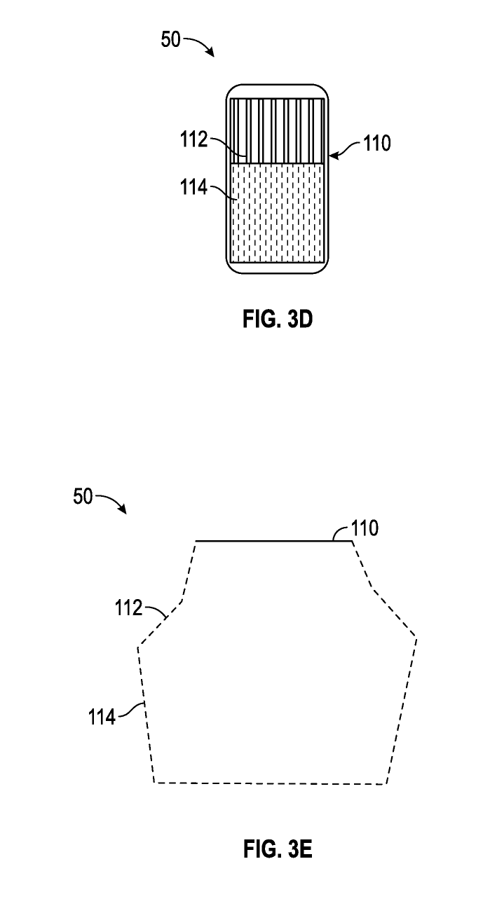

Referring now to FIGS. 3A-D, there are shown other embodiments of filters according to the present disclosure. FIG. 3A shows a filter 50 that may be used during reverse circulation. In reverse circulation, a surface fluid is pumped into the annulus 32 of a borehole 14. This fluid returns to the surface via the bore 64 of a drill string 16 or surface conduit 33 (FIG. 1). The FIG. 3A embodiment has a ring 70 formed as a half-torus, which is a general ring shape. A bag 72 is connected to the ring 70. The ring 70 may be or may be sufficiently pliable to deform when encountering restrictions in the borehole 14. The filter 50 of FIG. 3A may be positioned subsurface in the annulus 32 or at the surface along the surface conduit 33 (FIG. 1) that is in communication with the annulus 32. The ring 70 may be fixed to an outer surface of the conduit 33 or 35. For example, the ring 70 may seat on a collar, shoulder, or other upset along the outer surface of the conduit 33, 35.

Referring to FIG. 3B, there is shown a filter 50 having a multi-layered bag 80 with a common ring 82. In this non-limiting embodiment, the bag 80 has three layers: layers 84-88, while other embodiments can have greater or fewer layers. A tether 90, which may be a rope, cord, or string, connects the layers 84-88 to the ring 82. The length of the tether 90 is selected to have a preset axial spacing or offset between the layers 84-88. The layers 84-88 may have the same filtering parameters (e.g., particle size filtered, particle shape filtered, material filtered, etc.). Alternatively, the layers 84-88 may have different filtering parameters. As shown, layer 84 has transverse slits, layer 86 has longitudinal slits, and layer 88 has circular perforations.

The perforation shape may be varied to filter certain shaped debris (e.g., fibers or bars) while allowing other shapes (e.g., spheres) of similar size to pass through. Also, while the perforation shapes are varied in layers 84-88, it should be understood that perforation size may alternatively or additionally be varied within a layer or between layers. In embodiments, the perforations of the layers 84-88 may be arranged as a grid of slots orthogonal in a labyrinth-like form. The earlier or inner layer 84 may be relatively strong and configured to catch metal while the later layers 86, 88 may be relatively finer to catch non-metals. Thus, the layers 84-88 may be closed and disposed of separately.

In a related embodiment, the positions of the layers 84-88 are radially offset relative to one another. The offset is selected to allow relatively large round particles to pass while catching fibers / bar shaped particles of only slightly greater maximum length than the diameter of a drop ball or other selected structure. Also, the perforation size and orientation and the length of the tethers 90 can be sized to allow certain geometries (e.g., spheres) while blocking other geometries (e.g., bars). For instance, the perforations of the layers may be slots oriented orthogonal to each other. Such an arrangement may prevent a bar/shaped fiber to turn from layer to layer and get caught while relatively large round particles could pass.

Referring to FIG. 3C, there is shown a filter 50 with a closeable bag 100. The bag 100 may have an open end 92 that can be closed by a closure member 94. The closure member 94 may be a drawstring, strap, cord, rope, an elastic member, etc.

Referring to FIG. 3D, there is shown another filter 50 that has a bag 110 that has at least two different types of perforations 112, 114. For example, the upper perforations 112 have relatively long slots and the lower perforations 114 have relatively small perforations. This may be useful when using a ball drop to activate a well tool or to convey any other objects through the conduit and past the filter 50. When the ball (not shown) needs to pass, a viscous media may be pumped downhole to clog a majority of the lower perforations 114. The clogging increases the pressure differential and causes the larger slots 112 to increase in size, which allows the ball (not shown) to pass through the larger slots 112. Thereafter, a thinning agent may be pumped downhole to breakup or otherwise flush out the viscous media. After being so flushed, the bag 110 can now filter the fluid as before. While a chemical treatment has been described, a mechanical, hydraulic, electromagnetic or other activation may also be used.

The FIG. 3 embodiment may be used in a method to allow the use of a pump down ball or other object. The method may include the steps of filling a conduit upstream of the filter 50 with a viscous, degradable substance that clogs up the relatively smaller size perforations along a lower portion of the filter 50. The pressure differential caused by the clogging enlarges the relatively larger sized perforations along an upper portion of the filter 50. That is, the larger sized perforations expand from their nominal size, which is their pre-adjusted size. The pump down ball, or other object, is pumped down and passes through the enlarged larger sized perforations. Optionally, a degrading agent may be introduced to dissolve the viscous, degradable substance to reopen the smaller size perforations in the lower portion of the filter 50.

In still other embodiments, the filters may be positioned in parallel streams; e.g., one for the water/soap, one for the nitrogen/air in foam making.

Referring now to FIG. 3E, there is shown still another embodiment of a filter 50 according to the present disclosure that has at least two different sizes of perforations 120, 122. The shape of the filter 50 and the locations of the perforations 120, 122 may be selected to selectively admit or block entry of debris flowing along specific flow paths. For instance, the perforations 120 may be larger in size than the perforations 122. The perforations 120 may be positioned or located along a flow path that encounters less flow than the perforations 122. Thus, the perforations 120 may be located in positions with low flow rate, no flow rate, or negative flow rate.

In one mode of use, one or more of the filters 50 according to the present disclosure may be used during drilling operations. The filter 50 may be positioned along the conduit surface section 33 that directs drilling into the drill string 16. Additionally or alternatively, one or more of the filters 50 may be positioned along the conduit downhole section 35 (e.g., in a section of the drill string 16). In these cases, the filter 50 is secured in the conduit 33 and/ or 35 such that the bag 62 is disposed in the bore through which the drilling fluid flows. When so positioned, the bag 62 removes debris and other materials that exceed a predetermined size from the flowing fluid. Thus, components in the BHA 12 and elsewhere are protected from damaging contact from those debris and materials. When desired, the filter(s) 50 may be extracted from the conduit 31 and disposed of in conjunction or separated from the solids caught. The material of the filter bag may be biodegradable.

It should be understood that the present disclosure is not limited to the drilling environment. Any number of natural and engineered fluids with one or several phases may be pumped into the wellbore. The filters of the present disclosure may be advantageously used to filter those fluids as well. For example, the filter 50 may be used along a fluid line that conveys a lifting fluid into a produced fluid during artificial lift operations. The filter 50 may also be used during milling, reaming, underreaming, and other operations wherein rotating cutters or other downhole tools are energized using high-pressure fluid supplied from the surface. Still other operations that may benefit from the present teachings include logging run on pipe with downhole turbine powering LWD/“wireline” tools, junk baskets, hydraulic fracturing operations, stimulations, acidizing operations, and other completion operations wherein a surface fluid is conveyed into the wellbore via a suitable string.

From the above, it should be appreciated that filters according to the present disclosure may include layers that have different desirable properties, such as consecutively lower mesh size, different mesh shape or shape orientation, materials, strength, etc. Furthermore, the filters can be modified in terms of which particles it will catch or not. Additionally, the filters may be made at least partially of elastic material that open up pores upon increase of differential pressure across the bag. In yet other embodiments, the filters may be partially or completely covered with resin, improving desired properties such as abrasion resistance, stiffness, strength, mesh size or shape, surface tension. Additionally, the perforation or mesh size may be variable, depending on chemical environment, differential pressure across it, or other parameters. In still further embodiments, the filter may have a shape (e.g., a “mushroom shape”) that different sized perforations to selectively admit specific larger particles pass. Additionally, the perforations may be selectively positioned according to flow rates; e.g., low flow zones, no flow zones, negative flow zones.

From the above, it should be appreciated that bags according to the present disclosure may be deformed by methods other than chemically or mechanically. For instance, the filter may be deformed using an electromagnet near the filter and a ferromagnetic content in the material making up the filter or inside the filter. Initially, the perforations are a nominal size; i.e., a size before active adjustment. When the electromagnet is turned on, the filter is stretched. Alternatively, the filter may be selectively elongated by pushing it with a lever from upstream or by pulling it with a rope or similar mechanical member from downstream—either directly with the conduit opened or indirectly with the conduit closed and the flow on.

The foregoing description is directed to particular embodiments of the present disclosure for the purpose of illustration and explanation. It will be apparent, however, to one skilled in the art that many modifications and changes to the embodiment set forth above are possible without departing from the scope of the disclosure. It is intended that the following claims be interpreted to embrace all such modifications and changes.

What is claim is:

1. A filter for separating particles entrained in a fluid flowing into a wellbore from a surface location, the filter comprising:
a section of a conduit along which the fluid flows;
a ring fixed along the conduit; and
a bag connected to the ring, the bag being formed of at least a non-metal material and having perforations through which the fluid flows.

2. The filter of claim 1, wherein the section of the conduit is one of: (i) a surface section, and (ii) a downhole section.

3. The filter of claim 1, wherein the bag is formed of one of: (i) a composite material including the non-metal material and a metal; (ii) a polymer, (iii) a woven aramid fiber.

4. The filter of claim 1, wherein the bag is pliable.

5. The filter of claim 1, further comprising a closure member selectively closing an open end of the bag.

6. The filter of claim 1, wherein the bag has a plurality of layers.

7. The filter of claim 6, wherein each of the plurality of layers has a different filtering parameter.

8. The filter of claim 7, wherein the filtering parameters are controlled by at least one of: (i) perforation size, (ii) perforation geometry, (iii) perforation orientation, (iv) relative perforation orientation for each layer, (v) axial location of each filter, and (vi) radial offset of each layer.

9. The filter of claim 1, further comprising: a viscous media selected to clog at least a portion of the perforations, an agent selected to dissipate the viscous media, and a pump configured to pump the viscous media to the bag.

10. A method for separating particles entrained in a fluid flowing into a wellbore from a surface location, the filter comprising:
positioning a filter along a section of a conduit along which the fluid flows, wherein the filter include a ring and a bag connected to the ring, the bag being formed of at least a non-metal material and having perforations through which the fluid flows.

11. The method of claim 10, wherein the bag is formed of one of: (i) a composite material including the non-metal material and a metal; (ii) a polymer, (iii) a woven aramid fiber.

12. The method of claim 10, closing an open end of the bag to capture debris in the bag.

13. The method of claim 10, further comprising varying a size of at least a portion of the perforations while the filter is in the conduit.

14. The method of claim 13, wherein the size of at least a portion of the perforations is varied by using one of: (i) a pressure differential, (ii) a chemical, (iii) a mechanical member, and (iv) an electromagnetic waves.

15. The method of claim 10, further comprising conveying an object past the filter, wherein the object is larger than a nominal size of the perforations.

16. The method of claim 15, further comprising enlarging the size of at least one perforation to allow the object to pass through.

17. The method of claim 15, further comprising forming an opening in the filter to allow the object to pass through.

18. The method of claim 10, wherein the bag has a plurality of layers.

19. The method of claim 18, wherein each of the plurality of layers has a different filtering parameter.

20. The method of claim 10, further comprising filtering a debris of a first size in a first section of the filter and filtering a debris of a second size in a second section of the filter, wherein the second size is different from the first size.
